(19) United States
(12) Patent Application Publication
(10) Pub. No.: US 2024/0072986 A1
(43) Pub. Date: Feb. 29, 2024

(54) CONFIGURING DUPLEXING PATTERN

(71) Applicant: QUALCOMM Incorporated, San Diego, CA (US)

(72) Inventors: Yisheng XUE, San Diego, CA (US); Jing SUN, San Diego, CA (US); Chih-Hao LIU, San Diego, CA (US); Giovanni CHISCI, San Diego, CA (US); Xiaoxia ZHANG, San Diego, CA (US)

(21) Appl. No.: 17/823,345

(22) Filed: Aug. 30, 2022

(51) Int. Cl. H04L 5/14; H04W 72/04; H04W 76/10; H04W 76/28

(52) U.S. Cl. CPC H04L 5/14; H04W 72/04; H04W 76/10; H04W 76/28

(57) ABSTRACT

Various aspects of the present disclosure generally relate to wireless communication. In some aspects, a first user equipment (UE) may transmit, to a set of second UEs, information indicating a duplexing pattern of the first UE, wherein the duplexing pattern indicates one or more reception intervals of the first UE and one or more transmission intervals of the first UE. The UE may communicate in accordance with the duplexing pattern. Numerous other aspects are described.

### FIELD OF THE DISCLOSURE

Aspects of the present disclosure generally relate to wireless communication and to techniques and apparatuses for configuring a duplexing pattern.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a first user equipment (UE). The method may include transmitting, to a set of second UEs, information indicating a duplexing pattern of the first UE, wherein the duplexing pattern indicates one or more reception intervals of the first UE and one or more transmission intervals of the first UE. The method may include communicating in accordance with the duplexing pattern.

Some aspects described herein relate to a first UE for wireless communication. The first UE may include a memory and one or more processors coupled to the memory. The one or more processors may be configured to transmit, to a set of second UEs, information indicating a duplexing pattern of the first UE, wherein the duplexing pattern indicates one or more reception intervals of the first UE and one or more transmission intervals of the first UE. The one or more processors may be configured to communicate in accordance with the duplexing pattern.

Some aspects described herein relate to a non-transitory computer-readable medium that stores a set of instructions for wireless communication by a first UE. The set of instructions, when executed by one or more processors of the UE, may cause the UE to transmit, to a set of second UEs, information indicating a duplexing pattern of the first UE, wherein the duplexing pattern indicates one or more reception intervals of the first UE and one or more transmission intervals of the first UE. The set of instructions, when executed by one or more processors of the UE, may cause the UE to communicate in accordance with the duplexing pattern.

Some aspects described herein relate to an apparatus for wireless communication. The apparatus may include means for transmitting, to a set of second UEs, information indicating a duplexing pattern of the apparatus, wherein the duplexing pattern indicates one or more reception intervals of the apparatus and one or more transmission intervals of the apparatus. The apparatus may include means for communicating in accordance with the duplexing pattern.

Some aspects described herein relate to a computer program product comprises program instructions that when executed by one or more processors cause the one or more processors to: transmit, to a set of second UEs, information indicating a duplexing pattern of the first UE, wherein the duplexing pattern indicates at least one of one or more reception intervals of the first UE or one or more transmission intervals of the first UE; and communicate in accordance with the duplexing pattern.

Aspects generally include a method, apparatus, system, computer program product, non-transitory computer-readable medium, user equipment, base station, network entity, network node, wireless communication device, and/or processing system as substantially described herein with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example of sidelink communications, in accordance with the present disclosure.

FIG. 4 is a diagram illustrating an example of sidelink communications and access link communications, in accordance with the present disclosure.

FIG. 5 is a diagram illustrating an example of signaling associated with a duplexing pattern for sidelink communication, in accordance with the present disclosure.

FIG. 6 is a diagram illustrating an example of a duplexing pattern, in accordance with the present disclosure.

FIG. 7 is a diagram illustrating an example of a relationship between deaf intervals of a duplexing pattern, in accordance with the present disclosure.

FIG. 8 is a diagram illustrating an example of a relationship between transmission intervals and deaf intervals of a duplexing pattern, in accordance with the present disclosure.

FIG. 9 is a diagram illustrating an example of a condition associated with a duplexing pattern, in accordance with the present disclosure.

FIG. 10 is a diagram illustrating examples of channel occupancy times associated with a duplexing pattern, in accordance with the present disclosure.

FIG. 11 is a diagram illustrating an example process performed, for example, by a first UE, in accordance with the present disclosure.

FIG. 12 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

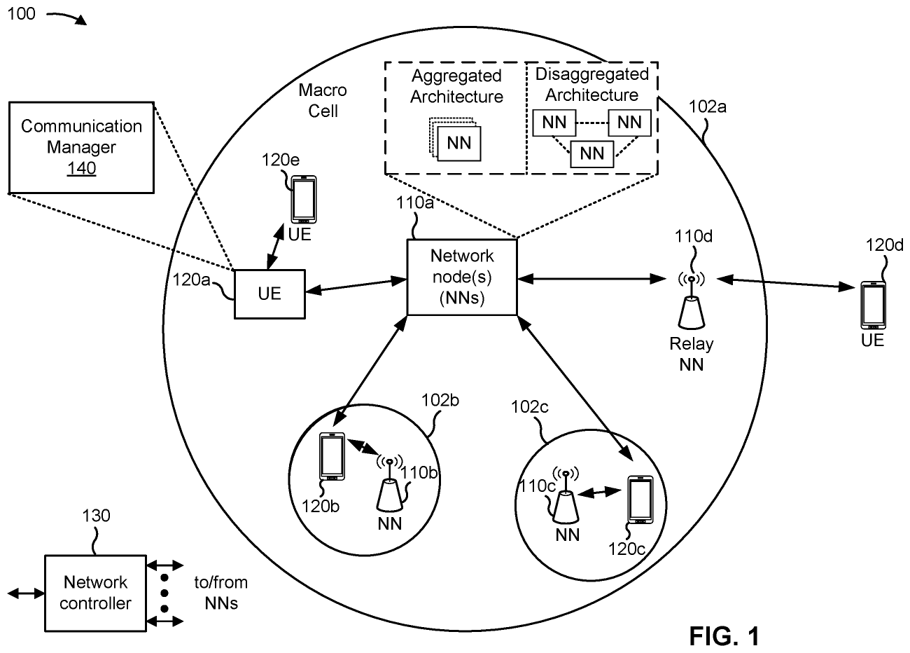

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may transmit, to a set of second UEs, information indicating a duplexing pattern of the UE 120, wherein the duplexing pattern indicates one or more reception intervals of the UE 120 and one or more transmission intervals of the UE 120; and communicate in accordance with the duplexing pattern. Additionally, or alternatively, the communication manager 140 may perform one or more other operations described herein.

As indicated above, FIG. 1 is provided as an example. Other examples may differ from what is described with regard to FIG. 1.

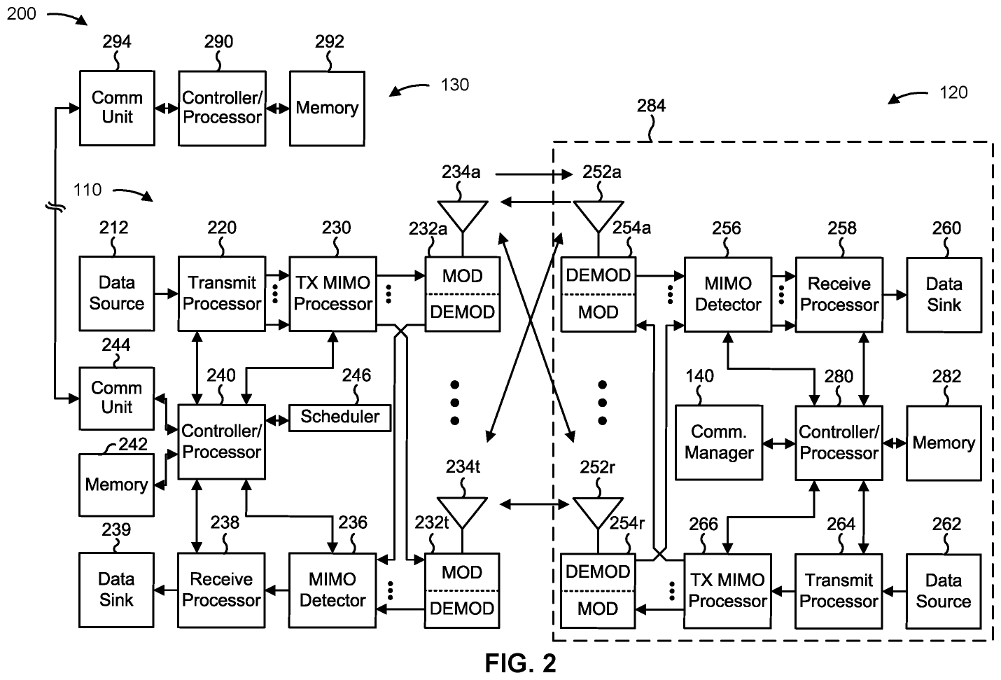

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T>1). The UE 120 may be equipped with a set of antennas 252a through 252r, such as R antennas (R>1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

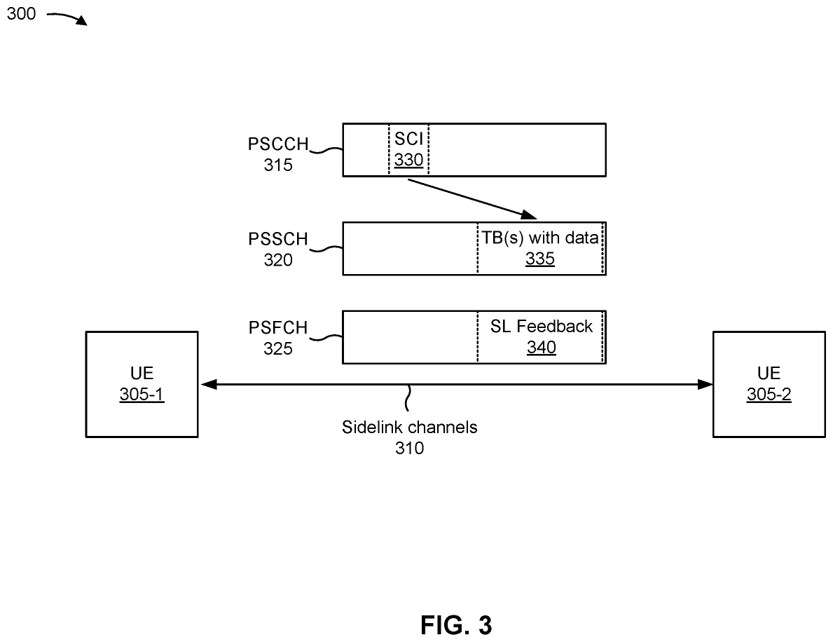

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 3-12).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 3-12).

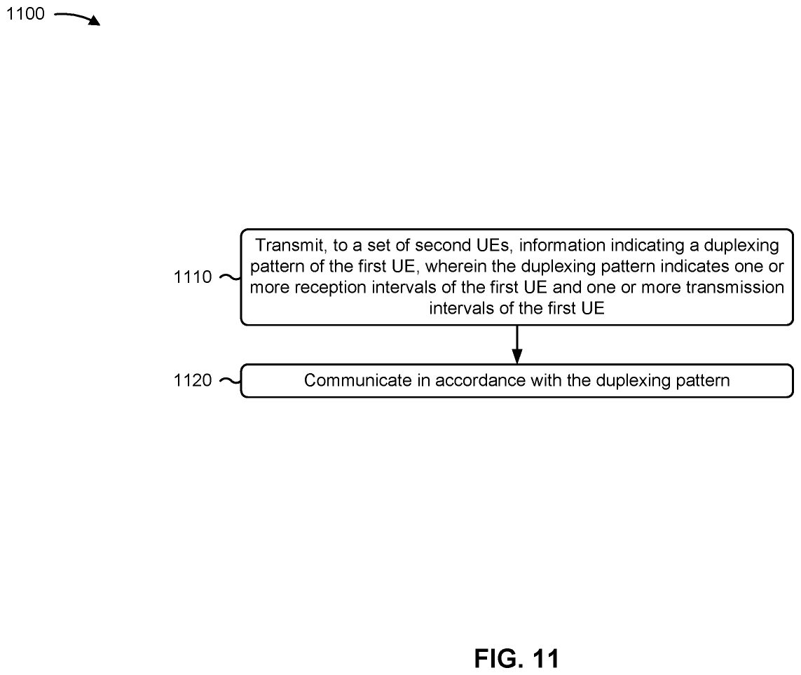

The controller/processor 240 of the network node 110, the controller/processor 280 of the UE 120, and/or any other component(s) of FIG. 2 may perform one or more techniques associated with sidelink communication, as described in more detail elsewhere herein. For example, the controller/processor 240 of the network node 110, the controller/processor 280 of the UE 120, and/or any other component(s) of FIG. 2 may perform or direct operations of, for example, process 1100 of FIG. 11, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1100 of FIG. 11, and/or other processes as described herein. In some examples, executing instructions may include running the instructions, converting the instructions, compiling the instructions, and/or interpreting the instructions, among other examples.

In some aspects, a first UE (e.g., the UE 120) includes means for transmitting, to a set of second UEs, information indicating a duplexing pattern of the first UE, wherein the duplexing pattern indicates one or more reception intervals of the first UE and one or more transmission intervals of the first UE; and/or means for communicating in accordance with the duplexing pattern. The means for the first UE to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

FIG. 3 is a diagram illustrating an example 300 of sidelink communications, in accordance with the present disclosure. Sidelink communications may be used for a variety of use cases, including exchanging safety-related messages for V2X communications, relaying communications from another UE to the network or vice versa, and other examples. In some examples, sidelink communication may occur on licensed bands, such as licensed sub-7-GHz bands. In some other aspects, sidelink communication may occur on unlicensed bands.

As shown in FIG. 3, a first UE 305-1 may communicate with a second UE 305-2 (and one or more other UEs 305) via one or more sidelink channels 310. The UEs 305-1 and 305-2 may communicate using the one or more sidelink channels 310 for P2P communications, D2D communications, V2X communications (e.g., which may include V2V communications, V2I communications, and/or V2P communications) and/or mesh networking. In some aspects, the UEs 305 (e.g., UE 305-1 and/or UE 305-2) may correspond to one or more other UEs described elsewhere herein, such as UE 120. In some aspects, the one or more sidelink channels 310 may use a PC5 interface and/or may operate in a high frequency band (e.g., the 5.9 GHz band). Additionally, or alternatively, the UEs 305 may synchronize timing of transmission time intervals (TTIs) (e.g., frames, subframes, slots, or symbols) using global navigation satellite system (GNSS) timing.

As further shown in FIG. 3, the one or more sidelink channels 310 may include a physical sidelink control channel (PSCCH) 315, a physical sidelink shared channel (PSSCH) 320, and/or a physical sidelink feedback channel (PSFCH) 325. The PSCCH 315 may be used to communicate control information, similar to a physical downlink control channel (PDCCH) and/or a physical uplink control channel (PUCCH) used for cellular communications with a network node 110 via an access link or an access channel. The PSSCH 320 may be used to communicate data, similar to a physical downlink shared channel (PDSCH) and/or a physical uplink shared channel (PUSCH) used for cellular communications with a network node 110 via an access link or an access channel. For example, the PSCCH 315 may carry sidelink control information (SCI) 330, which may indicate various control information used for sidelink communications, such as one or more resources (e.g., time resources, frequency resources, and/or spatial resources) where a transport block (TB) 335 may be carried on the PSSCH 320. The TB 335 may include data. The PSFCH 325 may be used to communicate sidelink feedback 340, such as hybrid automatic repeat request (HARQ) feedback (e.g., acknowledgement or negative acknowledgement (ACK/NACK) information), transmit power control (TPC), and/or a scheduling request (SR).

Although shown on the PSCCH 315, in some aspects, the SCI 330 may include multiple communications in different stages, such as a first stage SCI (SCI-1) and a second stage SCI (SCI-2). The SCI-1 may be transmitted on the PSCCH 315. The SCI-2 may be transmitted on the PSSCH 320. The SCI-1 may include, for example, an indication of one or more resources (e.g., time resources, frequency resources, and/or spatial resources) on the PSSCH 320, information for decoding sidelink communications on the PSSCH, a quality of service (QoS) priority value, a resource reservation period, a PSSCH demodulation reference signal (DMRS) pattern, an SCI format for the SCI-2, a beta offset for the SCI-2, a quantity of PSSCH DMRS ports, and/or a modulation and coding scheme (MCS). The SCI-2 may include information associated with data transmissions on the PSSCH 320, such as a hybrid automatic repeat request (HARQ) process ID, a new data indicator (NDI), a source identifier, a destination identifier, and/or a channel state information (CSI) report trigger.

In some aspects, the one or more sidelink channels 310 may use resource pools. A resource pool is a configured set of resources for sidelink communication. A resource pool can be associated with various configuration parameters. A scheduling assignment (e.g., included in SCI 330) may be transmitted in sub-channels using specific resource blocks (RBs) across time. In some aspects, data transmissions (e.g., on the PSSCH 320) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 305 may operate using a sidelink transmission mode (e.g., Mode 1) where resource selection and/or scheduling is performed by a network node 110. For example, the UE 305 may receive a grant (e.g., in downlink control information (DCI) or in a radio resource control (RRC) message, such as for configured grants) from the network node 110 for sidelink channel access and/or scheduling. In some aspects, a UE 305 may operate using a transmission mode (e.g., Mode 2) where resource selection and/or scheduling is performed by the UE 305 (e.g., rather than a network node 110). In some aspects, the UE 305 may perform resource selection and/or scheduling by sensing channel availability for transmissions. For example, the UE 305 may measure a received signal strength indicator (RSSI) parameter (e.g., a sidelink-RSSI (S-RSSI) parameter) associated with various sidelink channels, may measure a reference signal received power (RSRP) parameter (e.g., a PSSCH-RSRP parameter) associated with various sidelink channels, and/or may measure a reference signal received quality (RSRQ) parameter (e.g., a PSSCH-RSRQ parameter) associated with various sidelink channels, and may select a channel for transmission of a sidelink communication based at least in part on the measurement(s).

Additionally, or alternatively, the UE 305 may perform resource selection and/or scheduling using SCI 330 received in the PSCCH 315, which may indicate occupied resources and/or channel parameters. Additionally, or alternatively, the UE 305 may perform resource selection and/or scheduling by determining a channel busy ratio (CBR) associated with various sidelink channels, which may be used for rate control (e.g., by indicating a maximum number of resource blocks that the UE 305 can use for a particular set of subframes).

Based at least in part on a pre-configuration, sidelink UEs (e.g., UE 305) can communicate using resources of a Mode 2 based resource pool in the absence of a cellular network. To support a dynamic peer-to-peer network topology, Mode 2 UEs use sensing and/or reservation based random access to compete for channel access. OFDMA may be used to enlarge the number of random access channels to support a large number of UEs (of which each UE carries a low or moderate offered load on the channel). Time domain non-continuous retransmission may be used to mitigate half-duplex deafness, such as in the broadcast or groupcast context. There are various techniques to improve reliability in Mode 2, such as inter-UE coordination, discontinuous reception (DRX), and partial sensing.

In the transmission mode where resource selection and/or scheduling is performed by a UE 305, the UE 305 may generate sidelink grants, and may transmit the grants in SCI 330. A sidelink grant may indicate, for example, one or more parameters (e.g., transmission parameters) to be used for an upcoming sidelink transmission, such as one or more resource blocks to be used for the upcoming sidelink transmission on the PSSCH 320 (e.g., for TBs 335), one or more subframes to be used for the upcoming sidelink transmission, and/or a modulation and coding scheme (MCS) to be used for the upcoming sidelink transmission. In some aspects, a UE 305 may generate a sidelink grant that indicates one or more parameters for semi-persistent scheduling (SPS), such as a periodicity of a sidelink transmission. Additionally, or alternatively, the UE 305 may generate a sidelink grant for event-driven scheduling, such as for an on-demand sidelink message.

As indicated above, FIG. 3 is provided as an example. Other examples may differ from what is described with respect to FIG. 3.

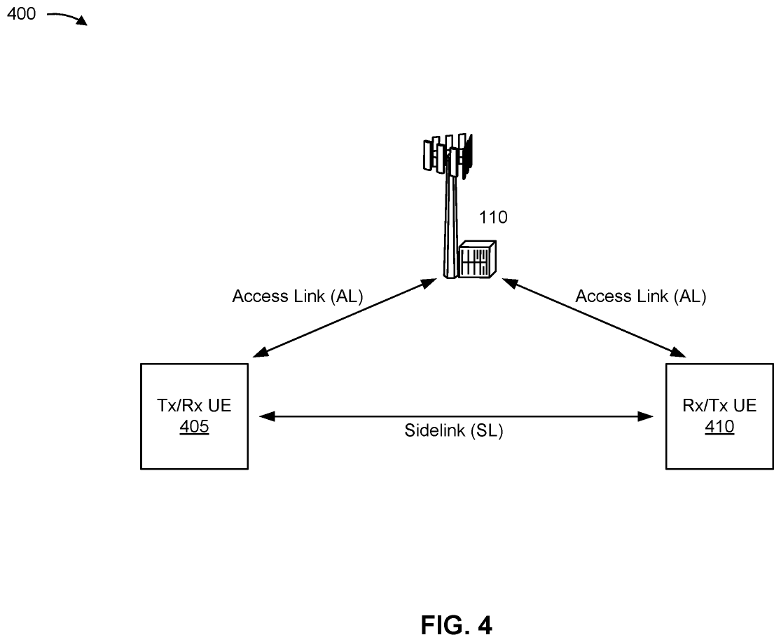

FIG. 4 is a diagram illustrating an example 400 of sidelink communications and access link communications, in accordance with the present disclosure.

As shown in FIG. 4, a transmitter (Tx)/receiver (Rx) UE 405 and an Rx/Tx UE 410 may communicate with one another via a sidelink, as described above in connection with FIG. 3. As further shown, in some sidelink modes, a network node 110 may communicate with the Tx/Rx UE 405 via a first access link. Additionally, or alternatively, in some sidelink modes, the network node 110 may communicate with the Rx/Tx UE 410 via a second access link. The Tx/Rx UE 405 and/or the Rx/Tx UE 410 may correspond to one or more UEs described elsewhere herein, such as the UE 120 of FIG. 1. Thus, a direct link between UEs 120 (e.g., via a PC5 interface) may be referred to as a sidelink, and a direct link between a network node 110 and a UE 120 (e.g., via a Uu interface) may be referred to as an access link. Sidelink communications may be transmitted via the sidelink, and access link communications may be transmitted via the access link. An access link communication may be either a downlink communication (from a network node 110 to a UE 120) or an uplink communication (from a UE 120 to a network node 110).

As mentioned above, sidelink communications may be deployed in an unlicensed band. As used herein, an unlicensed band is a band associated with a decentralized channel access mechanism. Examples of unlicensed bands include an FR1 unlicensed band (such as the 5 GHz or 6 GHz unlicensed band where WiFi, NR unlicensed (NR-U), and licensed-assisted access (LAA) technologies share spectrum using a decentralized channel access mechanism), an FR2 unlicensed band, and an FR2-2 unlicensed band. In some examples, sidelink communications deployed in new bands (such as unlicensed bands) may have use cases such as enhanced mobile broadband (eMBB), extended reality (XR), and so on. In some examples, such deployments may use a star topology, in which links are relatively sparse, with unicast communication as the dominant form of communication (as compared to groupcast or broadcast communication). Such deployments may be associated with higher data rates, more stringent quality-of-service requirements, and/or a higher loading level than traditional sidelink deployments.

Challenges may arise regarding the deployment of sidelink communications in unlicensed bands. As one example, use of channel occupancy time (COT)-based transmission (allowed by regulations to improve channel access efficiency in 5 GHz/6 GHz unlicensed bands) seems to favor time division multiplexing (TDM) over continuous slots, while legacy NR sidelink tends to involve communication using OFDMA over non-continuous slots. In addition, requirements for occupied channel bandwidth (OCB) from some regulations may lead to the usage of an interlaced waveform as in NR-U, in which a single channel access occupies non-contiguous resource blocks spreading at least 20 MHz (sometimes referred to as an LBT sub-band). The interlaced waveform may exacerbate inter-block interference (IBI). Consequently, the system may prefer TDM based channel access and may use OFDMA only in cases where IBI is well controlled (such as by gNB scheduling in Mode 1).

Some sidelink UEs may operate in a half-duplex mode. In a half-duplex mode, a UE can either transmit or receive at a given time, but not both at the same time. For example, in time division duplexing (TDD), a UE may not be capable of receiving during a transmission of the UE. The inability to receive during a transmission is referred to as half-duplex deafness. Some sidelink deployments have adopted non-continuous retransmissions to mitigate half-duplex deafness. Concerns regarding IBI may limit use of OFDMA in unlicensed bands for sidelink communication.

As mentioned above, COT based transmission may be used to provide channel access efficiency in unlicensed bands, such as those using a decentralized access mechanism such as listen-before-talk (LBT). For a Type 1 LBT, a device backs off for a random period of time before accessing the channel, the random period being sampled from a variable size contention window. For example, if a transmission fails (e.g., number of NACKs exceeds a threshold number) the contention window size may be doubled. After a successful Type 1 LBT, a node may be permitted to continuously transmit for up to 10 ms. Thus, a collision may last up to 10 ms, leading to a doubled contention window size. In some network topologies, such as star topologies, a node (e.g., a hub node of the star topology) may experience starvation due to frequent collisions with communications of the node.

Some techniques described herein provide signaling by a first UE (e.g., a sidelink UE) to one or more second UEs (e.g., one or more other sidelink UEs) of a duplexing pattern of the first UE. The duplexing pattern may indicate at least one of one or more reception intervals and/or one or more transmission intervals of the first UE, among other examples. The signaling can be broadcast signaling, groupcast signaling, unicast signaling, or a combination thereof. By signaling the duplexing pattern, the first UE and the one or more second UEs can improve efficiency and reliability of channel access, such as by avoiding transmission by a second UE on transmission intervals of the first UE, selecting resources for transmissions of a second UE during reception intervals of the first UE, and/or other examples described herein. In this way, the impact of half-duplex deafness is reduced, TDM communication in unlicensed bands is enabled (which reduces IBI), and deployment of sidelink communication in unlicensed bands is enabled.

According to some techniques described herein, in a resource allocation Mode 2 based sidelink resource pool, a sidelink UE can regulate, and inform others, of the sidelink UE's duplexing pattern to improve channel access efficiency for the sidelink resource pool. For example, the sidelink UE may broadcast information indicating a duplexing pattern (statically or semi-statically) that indicates when the sidelink UE will be in a reception mode (referred to herein as a reception interval) so that any other UE (say, a UE that does not have a unicast connection with the sidelink UE) can reliably transmit to the sidelink UE during these intervals. As another example, the sidelink UE may groupcast to a set of UEs (say, with which the sidelink UE has unicast connections) information indicating when the sidelink UE will be in transmission mode (such as when the sidelink UE will be deaf to reception, and referred to herein as a transmission interval or a deaf interval) or reception mode (such that any other UE can pursue a micro-sleep opportunity during such intervals). As yet another example, the sidelink UE may agree (statically or semi-statically) with a unicast-paired UE (a UE with which the sidelink UE has a unicast connection) when, among intervals not having been specified above, the sidelink UE will be in transmission mode or reception mode in a set of intervals. In addition, these intervals can be triggered to be active (and can fallback to being inactive) according to a condition such as a CSI report and/or a sidelink BSR report. In some aspects, the sidelink UE may dynamically reconfigure, using SCI, the duplexing patterns after obtaining a channel occupancy time (COT) via a Type 1 LBT.

As indicated above, FIG. 4 is provided as an example. Other examples may differ from what is described with respect to FIG. 4.

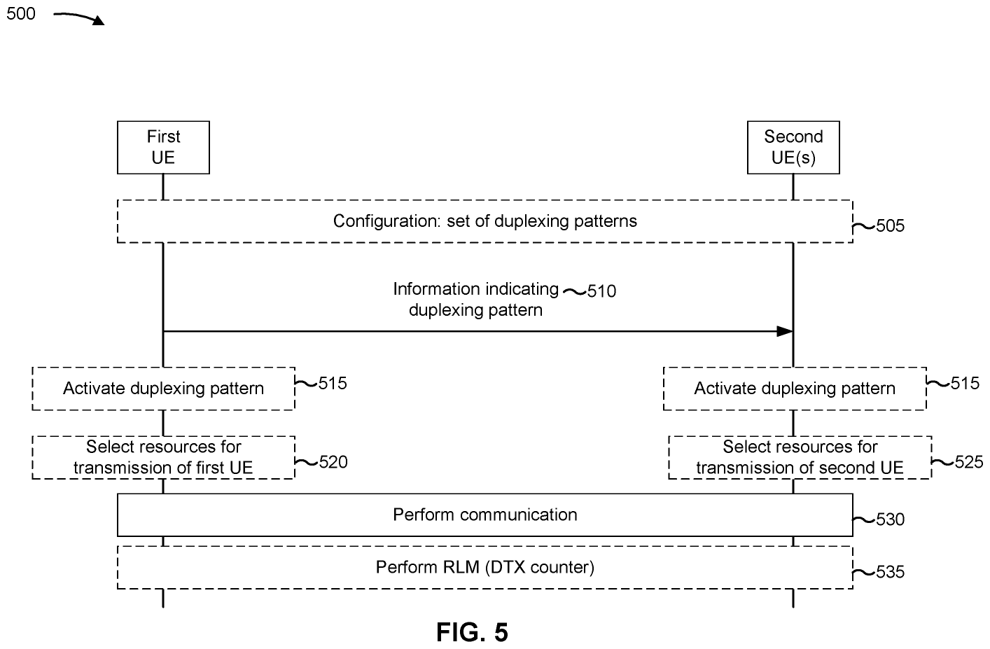

FIG. 5 is a diagram illustrating an example 500 of signaling associated with a duplexing pattern for sidelink communication, in accordance with the present disclosure. As shown, example 500 includes a first UE (e.g., UE 120, UE 305, UE 405, UE 410) and a set of second UEs (e.g., UE 120, UE 305, UE 405, UE 410). The set of second UEs may include one or more UEs. In some aspects, a second UE of the set of second UEs may be associated with a unicast connection with the first UE. In some other aspects, a second UE of the set of second UEs may not have a unicast connection with the first UE. In some aspects, the first UE and the set of second UEs may be configured with a sidelink resource pool. For example, the first UE and the set of second UEs may be configured to perform sidelink communications using the same sidelink resource pool. In some aspects, the sidelink resource pool is configured for UE selection of resources for communications (e.g., Mode 2 resource allocation). In some aspects, the first UE and the set of second UEs may perform the operations of FIGS. 5-10 in an unlicensed band (e.g., the duplexing pattern may pertain to resources in an unlicensed band). In some other aspects, the first UE and the set of second UEs may perform the operations of FIGS. 5-10 in a licensed band (e.g., the duplexing pattern may pertain to resources in a licensed band).

As shown in FIG. 5, and by reference number 505, in some aspects, the first UE and/or the set of second UEs may be configured with a set of duplexing patterns. For example, in some aspects, the first UE may select a duplexing pattern from the set of duplexing patterns and may transmit an indication of the selected duplexing pattern, as described below. Pre-configuration of a set of duplexing patterns may reduce overhead associated with signaling a selected duplexing pattern, as compared to explicitly signaling the duplexing pattern to the set of second UEs. In some aspects, a configuration of the sidelink resource pool used by the first UE and the set of second UEs (e.g., a Layer 3 configuration such as an RRC configuration) may indicate the set of duplexing patterns. For example, the configuration of the sidelink resource pool may indicate a mapping from a UE identifier (or a part of a UE identifier such as a partial UE identifier) to a duplexing pattern, such that a second UE can identify the duplexing pattern based at least in part on the UE identifier (or the part of the UE identifier) associated with the first UE. For example, sidelink control information associated with a communication may indicate the UE identifier (e.g., stage 2 sidelink control information may carry a source UE identifier and a destination UE identifier). Hence, with the above mapping in the configuration, any other UE can determine how to reliably reach either the source UE or the destination UE of a communication in particular transmission intervals or reception intervals.

As shown by reference number 510, the first UE may transmit, and the set of second UEs may receive, information indicating a duplexing pattern. In some aspects, the information indicating the duplexing pattern may indicate a selected duplexing pattern. For example, the selected duplexing pattern may be selected from the set of duplexing patterns as indicated by reference number 505, and a Layer 1 or Layer 2 (such as sidelink control information or a medium access control control element (MAC-CE)) indication may indicate the selected duplexing pattern from the set of duplexing patterns. In some aspects, the information indicating the duplexing pattern may include information indicating a UE identifier (or part of a UE identifier) that the second UE can use to identify the duplexing pattern associated with the first UE.

In some aspects, transmitting the information indicating the duplexing pattern is associated with a unicast connection establishment. For example, the first UE may provide the information indicating the duplexing pattern as a part of unicast connection establishment (such as via a message exchanged during unicast connection establishment), which may be considered a Layer 3 only provision of the information indicating the duplexing pattern. As another example, the first UE may groupcast the information indicating the duplexing pattern to the set of second UEs using a groupcast shared channel (e.g., a MAC-CE transmitted in a groupcast PSSCH), which may be considered a Layer 2 provision of the information indicating the duplexing pattern. Thus, the UE may groupcast the information indicating the duplexing pattern toward the set of second UEs.

In some aspects, the first UE may transmit the information indicating the duplexing pattern via an RRC message, such as a PC5-RRC message. For example, the first UE may transmit a duplexing pattern (such as a per-UE duplexing pattern) to a second UE of the set of second UEs via PC5-RRC signaling. In this example, the first UE and the second UE may exchange duplexing patterns via PC5-RRC signaling.

The duplexing pattern may indicate at least one of one or more reception intervals and/or one or more transmission intervals for the first UE. In some aspects, a reception interval is a time interval (e.g., a set of time resources) in which the first UE is configured to receive or is available to receive a communication. In some aspects, a reception interval is a time interval in which the first UE is configured or available for reception and not for transmission. In some aspects, a transmission interval is a time interval in which the first UE is configured to transmit a communication. In some aspects, a transmission interval is a time interval in which the first UE is configured for transmission and not for reception. In some aspects, a transmission interval is a time interval which the first UE has reserved or indicated for transmissions of the first UE.

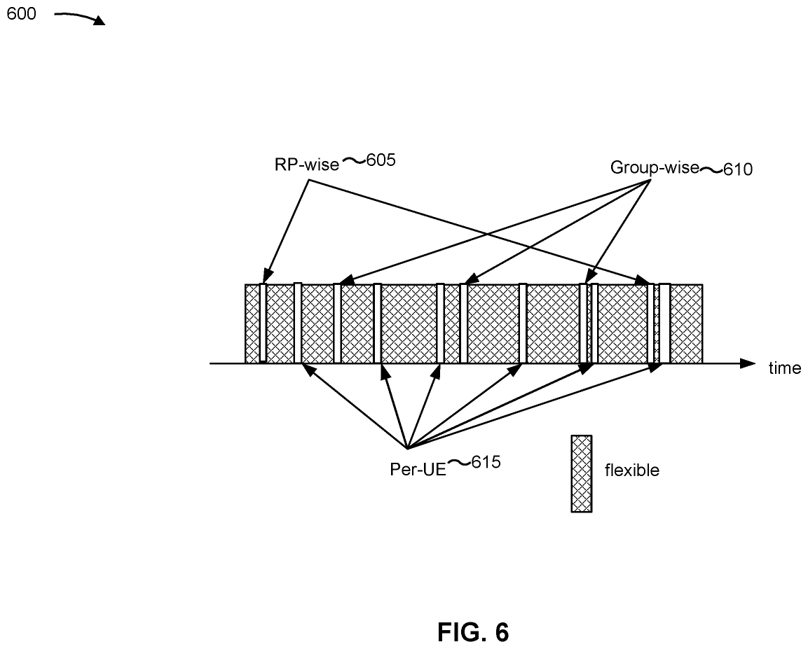

A duplexing pattern can include multiple transmission intervals and/or multiple reception intervals. In some aspects, the first UE may be associated with multiple duplexing patterns, such as different duplexing patterns for different sets of second UEs. In some aspects, the first UE may be associated with a single duplexing pattern including multiple transmission intervals and/or multiple reception intervals associated with different second UEs. FIG. 6 is a diagram illustrating an example 600 of a duplexing pattern, in accordance with the present disclosure. The duplexing pattern of example 600 illustrates only reception intervals, though in some aspects, a duplexing pattern can additionally or alternatively contain one or more transmission intervals.

As shown in FIG. 6, a first set of reception intervals 605 are configured for a resource pool (shown as “RP-wise”), a second set of reception intervals 610 are associated with a group of UEs (shown as “group-wise”), and a third set of reception intervals 615 are associated with an individual UE (shown as “per-UE”). As described with regard to reference number 510 of FIG. 5, the first UE may transmit, to the UEs associated with the reception intervals 605, 610, 615, information indicating the duplexing pattern. For example, the first UE may transmit, to a set of second UEs associated with the same resource pool as the first UE, information indicating the first set of reception intervals 605. As another example, the first UE and the set of second UEs associated with the same resource pool as the first UE may all be configured with the information indicating the first set of reception intervals 605 (by the first UE or by a network node). Thus, the first set of reception intervals 605 may be known to all UEs associated with the resource pool (which may include UEs with no unicast connection with the first UE).

As another example, the first UE may groupcast, to a set of second UEs, information indicating the second set of reception intervals 610. For example, the first UE may groupcast the information indicating the second set of reception intervals 610 to a set of second UEs that each have a respective unicast connection with the first UE and that are configured with the same resource pool as the first UE. This may be beneficial because the set of second UEs can pursue micro-sleep opportunities in the second set of reception intervals 610 if the set of second UEs are communicating only with the first UE.

As yet another example, the first UE may transmit information indicating the third set of reception intervals 615 to a second UE. For example, the first UE may transmit this information to the second UE, where the second UE is unicast paired with the first UE. In such examples, the second UE may have a traffic flow with the first UE (such as via a unicast connection with the first UE). For example, the traffic flow may be associated with a quality-of-service requirement. By signaling the third set of reception intervals 615 to the second UE, the second UE can take into account the reception intervals when selecting resources and/or configuring communications associated with the traffic flow, thereby ensuring that quality-of-service requirements are satisfied.

In some aspects, the duplexing pattern described herein may be considered static or semi-static. A static or semi-static duplexing pattern is a duplexing pattern that is assumed to be applicable until modified by other signaling. For example, a static or semi-static duplexing pattern may be applicable until de-configured, until replaced with another static or semi-static duplexing pattern, or until modified by SCI signaling, as described in more detail elsewhere herein.

As mentioned above, the first UE may be associated with (e.g., configured with) a sidelink resource pool. The intervals of the duplexing pattern (e.g., reception intervals, transmission intervals, and/or deaf intervals, which are described elsewhere herein) may be selected from resources of the sidelink resource pool. Thus, the duplexing pattern may indicate whether a resource of the resource pool is for transmission, reception, a deaf interval, or none of the above. In this way, resources of the sidelink resource pool may be considered flexible (e.g., subsequently configurable as resources for transmission, reception, or another purpose) until configured otherwise by a duplexing pattern.

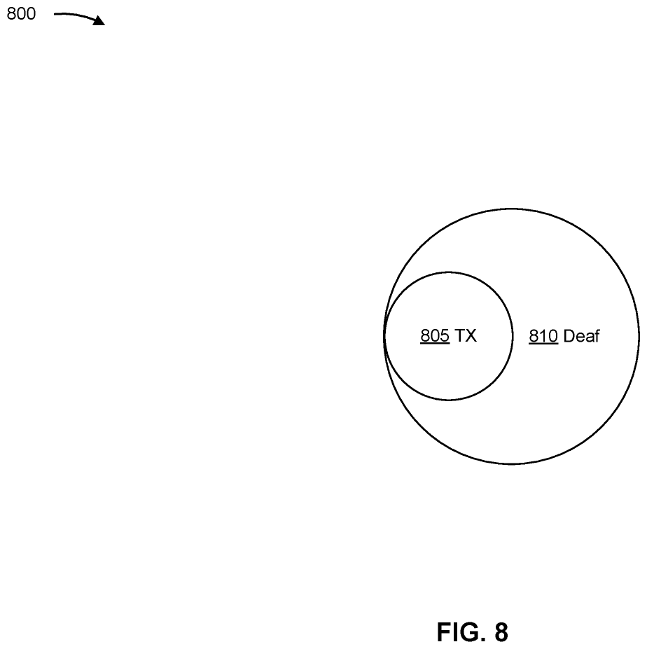

In some aspects, the duplexing pattern may indicate one or more deaf intervals. A deaf interval is an interval in which the first UE is configured not to (or cannot, or is unavailable to) receive a communication from a second UE that receives the duplexing pattern. In some aspects, a deaf interval may at least partially overlap with a transmission interval, as described in connection with FIG. 8. The indication of a deaf interval may enable the set of second UEs to avoid selecting resources for transmissions to the first UE during the deaf interval, thereby improving efficiency of sidelink communications.

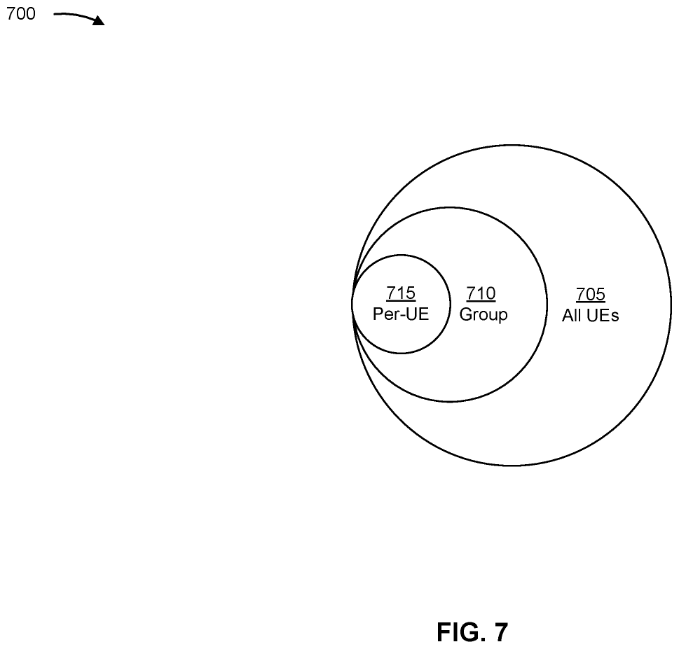

FIG. 7 is a diagram illustrating an example 700 of a relationship between deaf intervals of a duplexing pattern, in accordance with the present disclosure. The first UE may transmit, and a set of second UEs may receive, information indicating a duplexing pattern with one or more deaf intervals. In some aspects, as described above, the set of second UEs may include all UEs configured with a same resource pool as the first UE. In this example, the one or more deaf intervals may be known to all UEs in the resource pool. In some aspects, as described above, the set of second UEs may include a set of UEs, such as a set of UEs to which the duplexing pattern is groupcasted. In some aspects, the set of second UEs may include a unicast paired UE (e.g., a single second UE), as described above. In some aspects, different sets of deaf intervals may be indicated for these sets of UEs. For example, a first set of deaf intervals 705 may be indicated for all UEs configured with a same resource pool as the first UE. A second set of deaf intervals 710 (which, in some examples, may be selected from the first set of deaf intervals 705) may be signaled to the set of UEs such as via groupcast signaling. A third set of deaf intervals 715 (which, in some examples, may be selected from the first set of deaf intervals 705 and/or the second set of deaf intervals 710) may be signaled to the unicast paired UE. In some examples, the sets of deaf intervals 705, 710, and/or 715 may not overlap. For example, these sets of deaf intervals may not include the same deaf interval.

In some aspects, a transmission interval may at least partially overlap a deaf interval. For example, a first UE associated with half-duplex deafness (such that the first UE can only transmit or receive at a given time, not both) may be deaf to reception when transmitting. The first UE may transmit, to a set of second UEs, information indicating a duplexing pattern including a deaf interval and a transmission interval. FIG. 8 is a diagram illustrating an example 800 of a relationship between transmission intervals and deaf intervals of a duplexing pattern, in accordance with the present disclosure. As shown, a transmission interval 805 may be included in a deaf interval 810. In some aspects, a transmission interval 805 may partially overlap a deaf interval 810. In some aspects, a deaf interval 810 may include multiple transmission intervals 805. In some aspects, the first UE may transmit information indicating a first duplexing pattern to a first set of second UEs (e.g., all UEs associated with a same resource pool as the first UE), and may transmit information indicating a second duplexing pattern to a second set of second UEs (e.g., a group of UEs, or a unicast paired UE, of the first set of second UEs). The first duplexing pattern may indicate the deaf interval 810, and the second duplexing pattern may indicate one or more transmission intervals 805 within the deaf interval 810.

Returning to FIG. 5, in some aspects, a duplexing pattern may be associated with a condition. The condition may trigger activation of the duplexing pattern (such that the first UE and the set of second UEs begin communicating in accordance with the duplexing pattern) or deactivation of the duplexing pattern (such that the first UE and the set of second UEs cease communicating in accordance with the duplexing pattern and/or begin communicating in accordance with a different duplexing pattern). As shown by reference number 515, in some aspects, the first UE and the set of second UEs may activate the duplexing pattern indicated by reference number 510. For example, this activation may be based at least in part on a condition being satisfied.

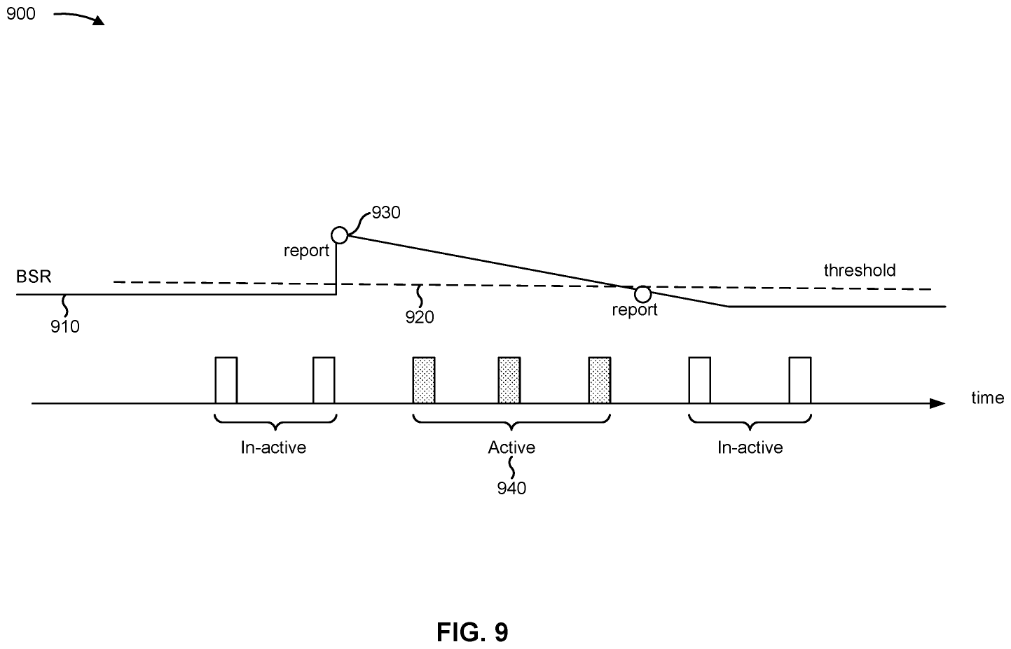

FIG. 9 is a diagram illustrating an example 900 of a condition associated with a duplexing pattern, in accordance with the present disclosure. Example 900 illustrates a condition associated with a buffer status report (BSR) size. A BSR size is a number of bits stored in a buffer of the first UE, as indicated by a BSR. The first UE may transmit a BSR to the set of second UEs indicating the BSR size. The BSR size is shown by reference number 910. A condition associated with a duplexing pattern is illustrated by the dashed line shown by reference number 920. The dashed line may represent a BSR size threshold. If the BSR size indicated by the BSR satisfies the BSR size threshold (such as at reference number 930), the first UE and the set of second UEs may activate the duplexing pattern, as shown by reference number 940. For example, the duplexing pattern (or a reception interval, transmission interval, or deaf interval of the duplexing pattern) may become active only after a sidelink handshake reporting buffer status exceeds a pre-defined threshold. If the BSR size indicated by the BSR fails to satisfy the BSR size threshold, the duplexing pattern (or a reception interval, transmission interval, or deaf interval of the duplexing pattern) may become inactive. For example, the duplexing pattern may fallback to an inactive state after a handshake reporting buffer status becomes smaller than the BSR size threshold or another threshold (which may indicate a different BSR size that may be higher or lower than the BSR size threshold). By selectively activating or deactivating the duplexing pattern according to the BSR size threshold, efficiency of sidelink communications may be improved in situations where the buffer size is relatively large (which may increase throughput), and flexibility of sidelink communications may be improved in situations where the buffer size is relatively small (which may provide improved adaptability for scheduling in view of channel conditions).

In some aspects, the condition may be associated with a channel state of a channel associated with the first UE. For example, the condition may be based at least in part on channel state information (CSI) derived from the channel associated with the first UE, such as based at least in part on the first UE or the set of second UEs measuring a reference signal (e.g., a sidelink reference signal, a CSI reference signal, or the like). In this example, a duplexing pattern or an interval of the duplexing pattern may become active when a CSI threshold associated with the duplexing pattern is satisfied, and may become inactive when the CSI threshold, or a different CSI threshold, associated with the duplexing pattern is no longer satisfied (the different CSI threshold may be higher. By selectively activating or deactivating the duplexing pattern according to the CSI threshold, efficiency of sidelink communications may be improved when the channel's condition is relatively poor (which may increase throughput and avoid further degradation of the channel), and flexibility of sidelink communications may be improved when the channel's condition is relatively good (which may provide improved adaptability for scheduling in view of channel conditions).

In some aspects, the condition (e.g., a threshold associated with the condition) may be pre-defined. For example, the condition may be indicated by the information indicating the duplexing pattern. As another example, the condition may be indicated by a configuration of the resource pool. As yet another example, the condition may be specified in a wireless communication specification. As still another example, the condition may be negotiated by the first UE and the set of second UEs.

Returning to FIG. 5, in some aspects, the first UE may transmit an indication to modify the duplexing pattern. For example, the first UE may transmit the indication via SCI, or the indication may be SCI (e.g., Layer 1 signaling). The modified duplexing pattern may change the state of one or more resources (e.g., one or more slots, one or more symbols, or the like) of the duplexing pattern. For example, the modified duplexing pattern may add a transmission interval, reception interval, or deaf interval to the duplexing pattern. As another example, the modified duplexing pattern may remove a transmission interval, a reception interval, or a deaf interval from the duplexing pattern. As yet another example, the modified duplexing pattern may lengthen or shorten a transmission interval, a reception interval, or a deaf interval. As another example, the modified duplexing pattern may change a resource of a transmission interval into a resource of a deaf interval or a reception interval, may change a resource of a deaf interval into a resource of a transmission interval or a reception interval, or may change a resource of a reception interval into a resource of a transmission interval or a deaf interval.

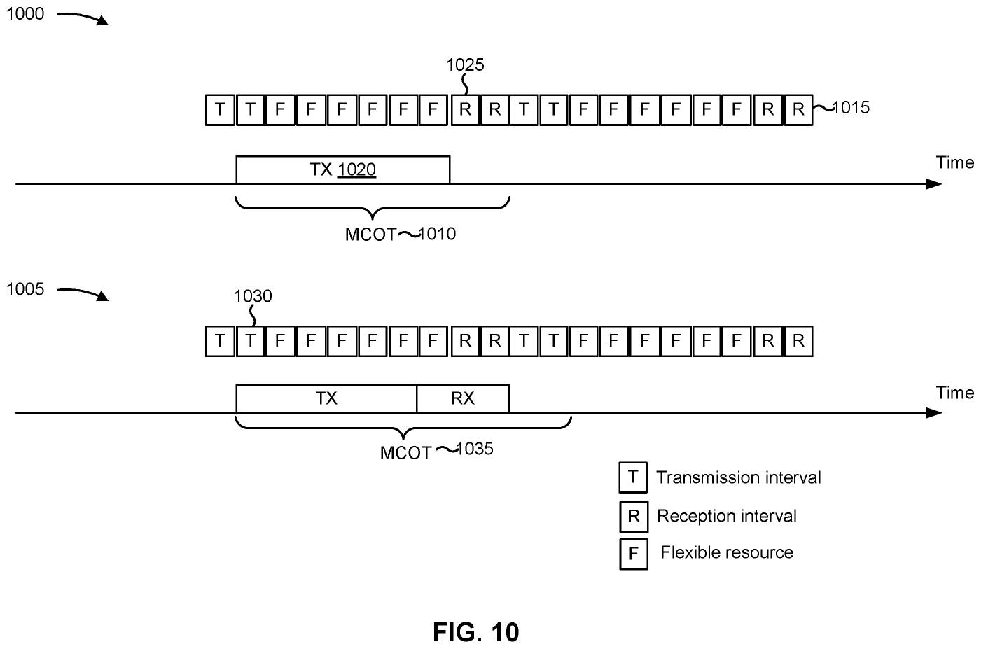

In some aspects, the modified duplexing pattern may be based at least in part on obtaining a COT, such as in accordance with an LBT procedure (e.g., LBT Type 1). For example, the first UE may obtain a COT, and may transmit SCI modifying the duplexing pattern after obtaining the COT. In some aspects, the modified duplex pattern may be preconfigured. For example, duplexing patterns may be preconfigured via static signaling or semi-static signaling. In some aspects, the SCI modifying the duplexing pattern may include an index corresponding to the preconfigured duplex pattern so that the overhead of the SCI may be reduced. FIG. 10 is a diagram illustrating examples 1000 and 1005 of COTs associated with a duplexing pattern, in accordance with the present disclosure. In example 1000, the UE obtains a COT 1010 (e.g., pursuant to a Type 1 LBT procedure). The UE may transmit information (such as COT structure information or the like) modifying the duplexing pattern 1015 such that there is a transmission interval 1020 within the COT 1010. The COT 1010 is illustrated as “MCOT” because a COT is associated with a maximum time length, referred to as a maximum COT (MCOT). For example, the transmission interval may occupy previously flexible resources, of a resource pool, that are within the COT 1010. As further shown, the transmission interval 1020 may end (e.g., before an MCOT time length has elapsed) prior to any existing reception intervals of the duplexing pattern, such as reception interval 1025.

Example 1005 is an example involving COT sharing. In COT sharing, one UE can share its COT with another UE. For example, the first UE may invite a second UE of the set of second UEs to perform a transmission to the first UE in a COT obtained by the first UE. In example 1005, the first UE may not share resources 1030 of a COT 1035 with a second UE if the resources 1030 have previously been indicated as belonging to a deaf interval or a transmission interval of the first UE. For example, the first UE may not be allowed to share the resources 1030 if the resources 1030 have previously been indicated as belonging to a deaf interval or a transmission interval of the first UE. For example, the first UE may refrain from sharing the resources 1030 if the resources 1030 have previously been indicated as belonging to a deaf interval or a transmission interval of the first UE.

Returning to FIG. 5, as shown by reference number 520, the first UE may select resources for a transmission of the first UE. For example, the first UE may select the resources based at least in part on the duplexing pattern of the first UE. Additionally, or alternatively, as shown by reference number 525, a second UE of the set of second UEs may select resources for a transmission of the one or more second UEs. For example, the second UE may select the resources based at least in part on the duplexing pattern of the first UE. As shown by reference number 530, the first UE and/or the second UE may perform a communication, such as a transmission by the first UE using a resource selected in connection with reference number 520 and/or a transmission by the second UE using a resource selected in connection with reference number 525. In some aspects, the first UE may select a resource that is included in a transmission interval of the first UE. In some aspects, the first UE may select a resource that is included in a deaf interval of the first UE. In some aspects, the first UE may prioritize selection of resources in one or more transmission intervals. For example, the UE may prioritize selection, for a transmission of the first UE, of resources included in transmission intervals over resources that are not included in transmission intervals. In some aspects, the second UE may select a resource, for a transmission to the first UE, that is included in a reception interval of the first UE. In some aspects, the second UE may select a resource, for a transmission to a UE other than the first UE, that is not in a transmission interval of the first UE (thereby reducing interference from the first UE).

In some aspects, the first UE may exclude reception intervals of the first UE's duplexing pattern from a resource selection window of the first UE. In some aspects, the second UE may exclude deaf intervals and/or transmission intervals of the first UE from a resource selection window, of the second UE, for selection of resources for a transmission to the first UE. In some aspects, when a reception interval indicated by the first UE is available in a candidate resource set, the second UE may prioritize selection of resources in the reception interval (e.g., as compared to performing random selection). Thus, the first UE and/or the second UE may perform duplexing pattern aware sensing and/or reevaluation.

In some aspects, the first UE and a second UE, of the set of second UEs, may perform inter-UE coordination. In inter-UE coordination, a UE B can request that a UE A provide a recommendation of a resource for channel access. UE A may transmit, to UE B (e.g., via a MAC-CE or SCI), an indication of one or more preferred resources and/or one or more non-preferred resources. For example, a non-preferred resource may correspond to a resource selected for a transmission by UE A, which renders the non-preferred resource unsuitable for a communication by UE B. As another example, a preferred resource may correspond to a resource that is available for reception by UE A. In some aspects, the first UE and/or the second UE may transmit an indication of one or more preferred resources based at least in part on a duplexing pattern. For example, if the second UE requests a recommendation of a resource for channel access, any preferred resource indicated by the indication of one or more preferred resources and/or one or more non-preferred resources from the first UE to the second UE may be regarded as a dynamically configured reception interval. In some aspects, the first UE may not recommend (e.g., may exclude from recommendation) any resource within a deaf interval or a transmission interval.

As shown by reference number 535, in some aspects, the first UE and/or a second UE, of the set of second UEs, may perform radio link monitoring (RLM). For example, the first UE and/or the second UE may monitor for radio link failure (RLF) based at least in part on a discontinuous transmission (DTX) counter. A transmitting UE may count a number of consecutive DTX indications received from a receiving UE on occasions on which the transmitting UE was expecting a hybrid automatic repeat request (HARD) response. In some aspects, the first UE and/or the second UE may monitor for RLF based at least in part on a duplexing pattern. For example, the first UE and/or the second UE may only increment a DTX counter if a transmission (e.g., a PSSCH) associated with DTX was transmitted in a sub-channel within a reception interval of a destination UE of the transmission. As another example, the first UE and/or the second UE may increment the DTX counter according to a weight based at least in part on the transmission occurring during the reception interval of the destination UE of the transmission (e.g., in a sub-channel during the reception interval). For example, the weight may be greater than 1 (e.g., the first UE and/or the second UE may increment the DTX counter (i.e., numConsecutiveDTX) by two instead of one). In some aspects, the first UE and/or the second UE may identify a DTX based at least in part on a DTX indication, and may increment the DTX counter based at least in part on identifying the DTX and the duplexing pattern, as described above. Thus, the first UE and/or the second UE may prioritize recovery from RLF during reception intervals. In some aspects, the first UE and/or the second UE may transmit a sidelink discontinuous reception configuration that is based at least in part on the duplexing pattern. For example, the first UE may arrange a sidelink DRX configuration of the first UE such that the first UE's active time occurs in a reception interval of the first UE. As another example, the second UE may arrange a sidelink DRX configuration of the second UE such that the second UE's active time occurs in a transmission interval of the first UE.

As indicated above, FIGS. 5-10 are provided as examples. Other examples may differ from what is described with regard to FIGS. 5-10.

FIG. 11 is a diagram illustrating an example process 1100 performed, for example, by a first UE, in accordance with the present disclosure. Example process 1100 is an example where the UE (e.g., UE 120) performs operations associated with configuring a duplexing pattern.

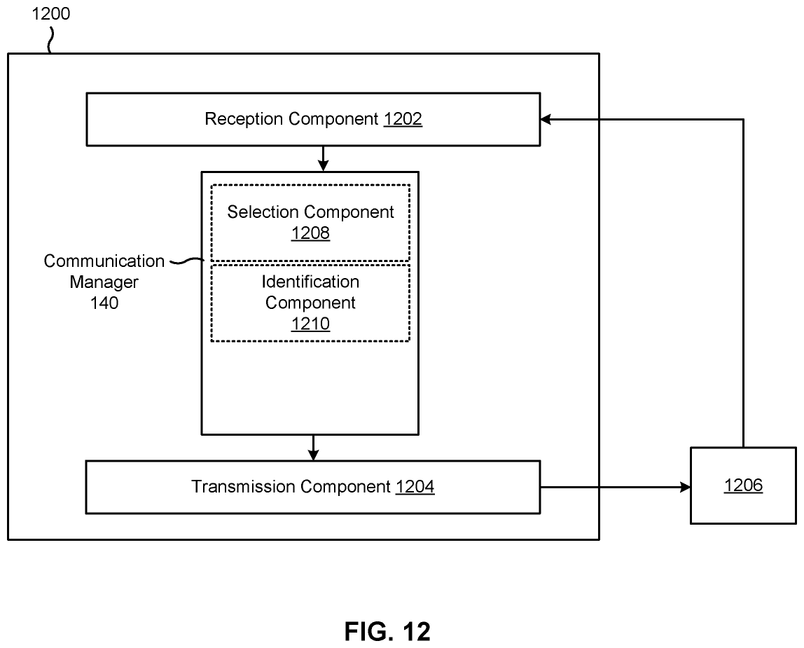

As shown in FIG. 11, in some aspects, process 1100 may include transmitting, to a set of second UEs, information indicating a duplexing pattern of the first UE, wherein the duplexing pattern indicates one or more reception intervals of the first UE and one or more transmission intervals of the first UE (block 1110). For example, the first UE (e.g., using communication manager 140 and/or transmission component 1204, depicted in FIG. 12) may transmit, to a set of second UEs, information indicating a duplexing pattern of the first UE, wherein the duplexing pattern indicates one or more reception intervals of the first UE and one or more transmission intervals of the first UE, as described above.

As further shown in FIG. 11, in some aspects, process 1100 may include communicating in accordance with the duplexing pattern (block 1120). For example, the first UE (e.g., using communication manager 140 and/or transmission component 1204, depicted in FIG. 12) may communicate in accordance with the duplexing pattern, as described above.

Process 1100 may include additional aspects, such as any single aspect or any combination of aspects described below and/or in connection with one or more other processes described elsewhere herein.

In a first aspect, the first UE and the set of second UEs are configured with a sidelink resource pool, wherein transmitting the information indicating the duplexing pattern to the set of second UEs is based at least in part on the set of second UEs being configured with the sidelink resource pool.

In a second aspect, alone or in combination with the first aspect, transmitting the information indicating the duplexing pattern further comprises broadcasting the information indicating the duplexing pattern.

In a third aspect, alone or in combination with one or more of the first and second aspects, transmitting the information indicating the duplexing pattern further comprises groupcasting the information indicating the duplexing pattern to the set of second UEs.

In a fourth aspect, alone or in combination with one or more of the first through third aspects, transmitting the information indicating the duplexing pattern further comprises transmitting the information via a unicast connection with the set of second UEs.

In a fifth aspect, alone or in combination with one or more of the first through fourth aspects, transmitting the information via the unicast connection is based at least in part on information received from the set of second UEs via the unicast connection.

In a sixth aspect, alone or in combination with one or more of the first through fifth aspects, process 1100 includes obtaining a channel occupancy time, and transmitting sidelink control information modifying the duplexing pattern after obtaining the channel occupancy time.

In a seventh aspect, alone or in combination with one or more of the first through sixth aspects, the modified duplexing pattern includes a transmission interval within the channel occupancy time.

In an eighth aspect, alone or in combination with one or more of the first through seventh aspects, the first UE refrains from sharing the channel occupancy time with a second UE during a deaf interval or a transmission interval of the first UE.

In a ninth aspect, alone or in combination with one or more of the first through eighth aspects, process 1100 includes transmitting a sidelink discontinuous reception configuration that is based at least in part on the duplexing pattern.

In a tenth aspect, alone or in combination with one or more of the first through ninth aspects, the information is transmitted via static signaling or semi-static signaling.

In an eleventh aspect, alone or in combination with one or more of the first through tenth aspects, the set of second UEs includes all UEs associated with a same sidelink resource pool as the first UE.

In a twelfth aspect, alone or in combination with one or more of the first through eleventh aspects, the set of second UEs includes all UEs associated with unicast connections with the first UE.

In a thirteenth aspect, alone or in combination with one or more of the first through twelfth aspects, the set of second UEs includes a UE with a quality-of-service requirement for a traffic flow on a unicast connection with the first UE.

In a fourteenth aspect, alone or in combination with one or more of the first through thirteenth aspects, the duplexing pattern indicates one or more deaf intervals in which the first UE cannot receive a communication.

In a fifteenth aspect, alone or in combination with one or more of the first through fourteenth aspects, a transmission interval of the one or more transmission intervals is within a deaf interval of the one or more deaf intervals.

In a sixteenth aspect, alone or in combination with one or more of the first through fifteenth aspects, the information indicating the duplexing pattern is based at least in part on a mapping between a UE identifier and the duplexing pattern.

In a seventeenth aspect, alone or in combination with one or more of the first through sixteenth aspects, the information indicating the duplexing pattern indicates a selected duplexing pattern of multiple configured duplexing patterns.

In an eighteenth aspect, alone or in combination with one or more of the first through seventeenth aspects, transmitting the information indicating the duplexing pattern is associated with a unicast connection establishment.

In a nineteenth aspect, alone or in combination with one or more of the first through eighteenth aspects, the information indicating the duplexing pattern is transmitted via a medium access control control element using a groupcast shared channel or a radio resource control message.

In a twentieth aspect, alone or in combination with one or more of the first through nineteenth aspects, the information indicating the duplexing pattern indicates a condition associated with the duplexing pattern.

In a twenty-first aspect, alone or in combination with one or more of the first through twentieth aspects, process 1100 includes transmitting inter-UE coordination information indicating a preferred resource for a transmission, wherein the preferred resource does not overlap a transmission interval of the one or more transmission intervals.

In a twenty-second aspect, alone or in combination with one or more of the first through twenty-first aspects, the preferred resource is not permitted to overlap any transmission interval of the one or more transmission intervals.

In a twenty-third aspect, alone or in combination with one or more of the first through twenty-second aspects, process 1100 includes selecting a resource for a transmission in accordance with the duplexing pattern.

In a twenty-fourth aspect, alone or in combination with one or more of the first through twenty-third aspects, the resource is selected from a set of resources, wherein the set of resources excludes the at least one of the one or more reception intervals, or a transmission interval of a destination UE of the transmission.

In a twenty-fifth aspect, alone or in combination with one or more of the first through twenty-fourth aspects, selecting the resource prioritizes resources of the one or more transmission intervals.

In a twenty-sixth aspect, alone or in combination with one or more of the first through twenty-fifth aspects, process 1100 includes identifying a discontinuous transmission (DTX), wherein a DTX counter is incremented only if a transmission associated with the DTX was during a reception interval of a destination UE of the transmission.

In a twenty-seventh aspect, alone or in combination with one or more of the first through twenty-sixth aspects, process 1100 includes identifying a DTX, wherein a DTX counter is incremented according to a weight based at least in part on a transmission associated with the DTX occurring during a reception interval of a destination UE of the transmission.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication, in accordance with the present disclosure. The apparatus 1200 may be a UE, or a UE may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include the communication manager 140. The communication manager 140 may include one or more of a selection component 1208 or an identification component 1210, among other examples.

In some aspects, the apparatus 1200 may be configured to perform one or more operations described herein in connection with FIGS. 3-10. Additionally, or alternatively, the apparatus 1200 may be configured to perform one or more processes described herein, such as process 1100 of FIG. 11, or a combination thereof. In some aspects, the apparatus 1200 and/or one or more components shown in FIG. 12 may include one or more components of the UE described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the UE described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the UE described in connection with FIG. 2. In some aspects, the transmission component 1204 may be co-located with the reception component 1202 in a transceiver.

The transmission component 1204 may transmit, to a set of second UEs, information indicating a duplexing pattern of the first UE, wherein the duplexing pattern indicates at least one of one or more reception intervals of the first UE or one or more transmission intervals of the first UE. The transmission component 1204 or the reception component 1202 may communicate in accordance with the duplexing pattern.

The transmission component 1204 may transmit sidelink control information modifying the duplexing pattern after obtaining the channel occupancy time.

The transmission component 1204 may transmit a sidelink discontinuous reception configuration that is based at least in part on the duplexing pattern.

The transmission component 1204 may transmit inter-UE coordination information indicating a preferred resource for a transmission, wherein the preferred resource does not overlap a transmission interval of the one or more transmission intervals.

The selection component 1208 may select a resource for a transmission in accordance with the duplexing pattern.

The identification component 1210 may identify a DTX, wherein a DTX counter is incremented only if a transmission associated with the DTX was during a reception interval of a destination UE of the transmission.

The identification component 1210 may identify a DTX, wherein a DTX counter is incremented according to a weight based at least in part on a transmission associated with the DTX occurring during a reception interval of a destination UE of the transmission.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a first user equipment (UE), comprising: transmitting, to a set of second UEs, information indicating a duplexing pattern of the first UE, wherein the duplexing pattern indicates at least one of one or more reception intervals of the first UE or one or more transmission intervals of the first UE; and communicating in accordance with the duplexing pattern.

Aspect 2: The method of Aspect 1, wherein the first UE and the set of second UEs are configured with a sidelink resource pool, wherein transmitting the information indicating the duplexing pattern to the set of second UEs is based at least in part on the set of second UEs being configured with the sidelink resource pool.

Aspect 3: The method of any of Aspects 1-2, wherein transmitting the information indicating the duplexing pattern further comprises broadcasting the information indicating the duplexing pattern.

Aspect 4: The method of any of Aspects 1-3, wherein transmitting the information indicating the duplexing pattern further comprises groupcasting the information indicating the duplexing pattern to the set of second UEs.

Aspect 5: The method of any of Aspects 1-4, wherein transmitting the information indicating the duplexing pattern further comprises transmitting the information via a unicast connection with the set of second UEs.

Aspect 6: The method of Aspect 5, wherein transmitting the information via the unicast connection is based at least in part on information received from the set of second UEs via the unicast connection.

Aspect 7: The method of any of Aspects 1-6, further comprising: obtaining a channel occupancy time; and transmitting sidelink control information modifying the duplexing pattern after obtaining the channel occupancy time.

Aspect 8: The method of Aspect 7, wherein the modified duplexing pattern includes a transmission interval within the channel occupancy time.

Aspect 9: The method of Aspect 7, wherein the first UE refrains from sharing the channel occupancy time with a second UE during a deaf interval or a transmission interval of the first UE.

Aspect 10: The method of any of Aspects 1-9, further comprising transmitting a sidelink discontinuous reception configuration that is based at least in part on the duplexing pattern.

Aspect 11: The method of any of Aspects 1-10, wherein the information is transmitted via static signaling or semi-static signaling.

Aspect 12: The method of any of Aspects 1-11, wherein the set of second UEs includes all UEs associated with a same sidelink resource pool as the first UE.

Aspect 13: The method of any of Aspects 1-12, wherein the set of second UEs includes all UEs associated with unicast connections with the first UE.

Aspect 14: The method of any of Aspects 1-13, wherein the set of second UEs includes a UE with a quality-of-service requirement for a traffic flow on a unicast connection with the first UE.

Aspect 15: The method of any of Aspects 1-14, wherein the duplexing pattern indicates one or more deaf intervals in which the first UE cannot receive a communication.

Aspect 16: The method of Aspect 15, wherein a transmission interval of the one or more transmission intervals is within a deaf interval of the one or more deaf intervals.

Aspect 17: The method of any of Aspects 1-16, wherein the information indicating the duplexing pattern is based at least in part on a mapping between a UE identifier and the duplexing pattern.

Aspect 18: The method of any of Aspects 1-17, wherein the information indicating the duplexing pattern indicates a selected duplexing pattern of multiple configured duplexing patterns.

Aspect 19: The method of any of Aspects 1-18, wherein transmitting the information indicating the duplexing pattern is associated with a unicast connection establishment.

Aspect 20: The method of any of Aspects 1-19, wherein the information indicating the duplexing pattern is transmitted via a medium access control control element using a groupcast shared channel or a radio resource control message.

Aspect 21: The method of any of Aspects 1-20, wherein the information indicating the duplexing pattern indicates a condition associated with the duplexing pattern.

Aspect 22: The method of any of Aspects 1-21, further comprising: transmitting inter-UE coordination information indicating a preferred resource for a transmission, wherein the preferred resource does not overlap a transmission interval of the one or more transmission intervals.

Aspect 23: The method of Aspect 22, wherein the preferred resource is not permitted to overlap any transmission interval of the one or more transmission intervals.

Aspect 24: The method of any of Aspects 1-23, further comprising: selecting a resource for a transmission in accordance with the duplexing pattern.

Aspect 25: The method of Aspect 24, wherein the resource is selected from a set of resources, wherein the set of resources excludes the at least one of: the one or more reception intervals, or a transmission interval of a destination UE of the transmission.

Aspect 26: The method of Aspect 24, wherein selecting the resource prioritizes resources of the one or more transmission intervals.

Aspect 27: The method of any of Aspects 1-26, further comprising: identifying a discontinuous transmission (DTX), wherein a DTX counter is incremented only if a transmission associated with the DTX was during a reception interval of a destination UE of the transmission.

Aspect 28: The method of any of Aspects 1-27, further comprising: identifying a discontinuous transmission (DTX), wherein a DTX counter is incremented according to a weight based at least in part on a transmission associated with the DTX occurring during a reception interval of a destination UE of the transmission.

Aspect 29: The method of Aspect 21, wherein the condition is associated with a buffer status report size or a channel state of a channel.

Aspect 30: The method of any of Aspects 1-29, further comprising activating the duplexing pattern based at least in part on satisfying a threshold condition.

Aspect 31: The method of Aspect 30, wherein the duplexing pattern is activated when a buffer status report of the first UE is above a threshold.

Aspect 32: The method of Aspect 30, wherein the duplexing pattern is activated when a channel state of a channel associated with the first UE is below a threshold.

Aspect 33: An apparatus for wireless communication at a device, comprising a processor; memory coupled with the processor; and instructions stored in the memory and executable by the processor to cause the apparatus to perform the method of one or more of Aspects 1-32.

Aspect 34: A device for wireless communication, comprising a memory and one or more processors coupled to the memory, the one or more processors configured to perform the method of one or more of Aspects 1-32.

Aspect 35: An apparatus for wireless communication, comprising at least one means for performing the method of one or more of Aspects 1-32.

Aspect 36: A non-transitory computer-readable medium storing code for wireless communication, the code comprising instructions executable by a processor to perform the method of one or more of Aspects 1-32.

Aspect 37: A non-transitory computer-readable medium storing a set of instructions for wireless communication, the set of instructions comprising one or more instructions that, when executed by one or more processors of a device, cause the device to perform the method of one or more of Aspects 1-32.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A first user equipment (UE) for wireless communication, comprising:
a memory; and
one or more processors, coupled to the memory, configured to:
transmit, to a set of second UEs, information indicating a duplexing pattern of the first UE, wherein the duplexing pattern indicates one or more reception intervals of the first UE and one or more transmission intervals of the first UE; and
communicate in accordance with the duplexing pattern.

2. The first UE of claim 1, wherein the first UE and the set of second UEs are configured with a sidelink resource pool, wherein transmitting the information indicating the duplexing pattern to the set of second UEs is based at least in part on the set of second UEs being configured with the sidelink resource pool.

3. The first UE of claim 1, wherein the one or more processors, to transmit the information indicating the duplexing pattern, are configured to broadcast the information indicating the duplexing pattern.

4. The first UE of claim 1, wherein the one or more processors, to transmit the information indicating the duplexing pattern, are configured to groupcast the information indicating the duplexing pattern to the set of second UEs.

5. The first UE of claim 1, wherein the one or more processors, to transmit the information indicating the duplexing pattern, are configured to transmit the information via one or more unicast connections with the set of second UEs.

6. The first UE of claim 5, wherein transmitting the information via the one or more unicast connections is based at least in part on information received from the set of second UEs via the unicast connection.

7. The first UE of claim 1, wherein the one or more processors are further configured to:
obtain a channel occupancy time; and
transmit sidelink control information modifying the duplexing pattern after obtaining the channel occupancy time.

8. The first UE of claim 1, wherein the one or more processors are further configured to transmit a sidelink discontinuous reception configuration that is based at least in part on the duplexing pattern.

9. The first UE of claim 1, wherein the information is transmitted via static signaling or semi-static signaling.

10. The first UE of claim 1, wherein the set of second UEs includes all UEs associated with a same sidelink resource pool as the first UE.

11. The first UE of claim 1, wherein the set of second UEs includes all UEs associated with unicast connections with the first UE.

12. The first UE of claim 1, wherein the set of second UEs includes a UE with a quality-of-service requirement for a traffic flow on a unicast connection with the first UE.

13. The first UE of claim 1, wherein the duplexing pattern indicates one or more deaf intervals in which the first UE cannot receive a communication.

14. The first UE of claim 1, wherein the information indicating the duplexing pattern is based at least in part on a mapping between a UE identifier and the duplexing pattern.

15. The first UE of claim 1, wherein the information indicating the duplexing pattern indicates a selected duplexing pattern of multiple configured duplexing patterns.

16. The first UE of claim 1, wherein transmitting the information indicating the duplexing pattern is associated with a unicast connection establishment.

17. The first UE of claim 1, wherein the information indicating the duplexing pattern indicates a condition associated with the duplexing pattern.

18. The first UE of claim 1, wherein the one or more processors are further configured to:
transmit inter-UE coordination information indicating a preferred resource for a transmission, wherein the preferred resource does not overlap a transmission interval of the one or more transmission intervals.

19. The first UE of claim 1, wherein the one or more processors are further configured to:
select a resource for a transmission in accordance with the duplexing pattern.

20. The first UE of claim 1, wherein the one or more processors are further configured to:
identify a discontinuous transmission (DTX), wherein a DTX counter is incremented only if a transmission associated with the DTX was during a reception interval of a destination UE of the transmission.

21. The first UE of claim 1, wherein the one or more processors are further configured to:
identify a discontinuous transmission (DTX), wherein a DTX counter is incremented according to a weight based at least in part on a transmission associated with the DTX occurring during a reception interval of a destination UE of the transmission.

22. The first UE of claim 1, wherein the one or more processors are further configured to activate the duplexing pattern based at least in part on satisfying a threshold condition.

23. The first UE of claim 22, wherein the duplexing pattern is activated when a buffer status report of the first UE is above a threshold.

24. The first UE of claim 22, wherein the duplexing pattern is activated when a channel state of a channel associated with the first UE is below a threshold.

25. A method of wireless communication performed by a first user equipment (UE), comprising:
transmitting, to a set of second UEs, information indicating a duplexing pattern of the first UE, wherein the duplexing pattern indicates one or more reception intervals of the first UE and one or more transmission intervals of the first UE; and
communicating in accordance with the duplexing pattern.

26. The method of claim 25, wherein the first UE and the set of second UEs are configured with a sidelink resource pool, wherein transmitting the information indicating the duplexing pattern to the set of second UEs is based at least in part on the set of second UEs being configured with the sidelink resource pool.

27. A non-transitory computer-readable medium storing a set of instructions for wireless communication, the set of instructions comprising:
one or more instructions that, when executed by one or more processors of a first user equipment (UE), cause the first UE to:
transmit, to a set of second UEs, information indicating a duplexing pattern of the first UE, wherein the duplexing pattern indicates one or more reception intervals of the first UE and one or more transmission intervals of the first UE; and
communicate in accordance with the duplexing pattern.

28. The non-transitory computer-readable medium of claim 27, wherein the first UE and the set of second UEs are configured with a sidelink resource pool, wherein transmitting the information indicating the duplexing pattern to the set of second UEs is based at least in part on the set of second UEs being configured with the sidelink resource pool.

29. An apparatus for wireless communication, comprising:
means for transmitting, to a set of second user equipments (UEs), information indicating a duplexing pattern of the apparatus, wherein the duplexing pattern indicates one or more reception intervals of the apparatus and one or more transmission intervals of the apparatus; and
means for communicating in accordance with the duplexing pattern.

30. The apparatus of claim 29, wherein the apparatus and the set of second UEs are configured with a sidelink resource pool, wherein transmitting the information indicating the duplexing pattern to the set of second UEs is based at least in part on the set of second UEs being configured with the sidelink resource pool.
